(19) United States
(12) Patent Application Publication
(10) Pub. No.: US 2013/0082929 A1
(43) Pub. Date: Apr. 4, 2013

(54) TOUCH-SENSITIVE DEVICE AND METHOD FOR CONTROLLING DISPLAY OF VIRTUAL KEYBOARD

(71) Applicant: QIANG YOU, Shenzhen City (CN)

(72) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/282,471

(22) Filed: Oct. 27, 2011

(30) Foreign Application Priority Data
Sep. 29, 2011 (CN) 201110300279.1

(51) Int. Cl. G06F 3/02

(52) U.S. Cl. 345/168

(57) ABSTRACT

A touch-sensitive device includes a touch-sensitive screen and a processor. The processor divides a virtual keyboard into a number of sub-keyboards, determines an input touch track according to touch signals from the touch-sensitive screen, and displays a particular sub-keyboard according to the input touch track. A related method is also provided.

### BACKGROUND

1. Technical Field

The present disclosure relates to touch devices and, particularly, to a touch-sensitive device capable of controlling the display of a virtual keyboard and a method thereof.

2. Description of Related Art

Electronic devices which provide a virtual full qwerty keyboard on a touch-sensitive screen are widely used. However, the typical virtual full qwerty keyboard is usually difficult to use since the keys are reduced in size.

### BRIEF DESCRIPTION OF THE DRAWINGS

The components of the drawings are not necessarily drawn to scale, the emphasis instead being placed upon clearly illustrating the principles of a touch device and a method for controlling the display of a virtual keyboard. Moreover, in the drawings, like reference numerals designate corresponding parts throughout the several views.

FIG. 1 is a block diagram of a touch-sensitive device in accordance with an exemplary embodiment.

FIG. 2 is a schematic view of a user interface including a virtual keyboard, in accordance with an exemplary embodiment.

FIG. 3 is a schematic view showing the divisions of a first button area of the virtual keyboard of FIG. 2, in accordance with an exemplary embodiment.

FIGS. 4-6 are schematic views showing a number of sub-keyboards, in accordance with an exemplary embodiment.

FIG. 7 is a schematic view showing one sub-keyboard displayed in the user interface of FIG. 2, in accordance with an exemplary embodiment.

FIG. 8 is a flowchart of a method for controlling the display of sub-keyboards, in accordance with an exemplary embodiment.

### DETAILED DESCRIPTION

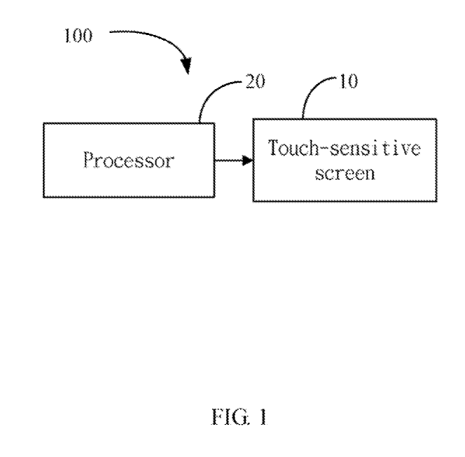

Referring to FIG. 1, an embodiment of a touch-sensitive device 100 is illustrated. The device 100 includes a touch-sensitive screen 10 and a processor 20. The device 100 may be a mobile phone, a personal digital assistant (PDA), a tablet computer, or the like.

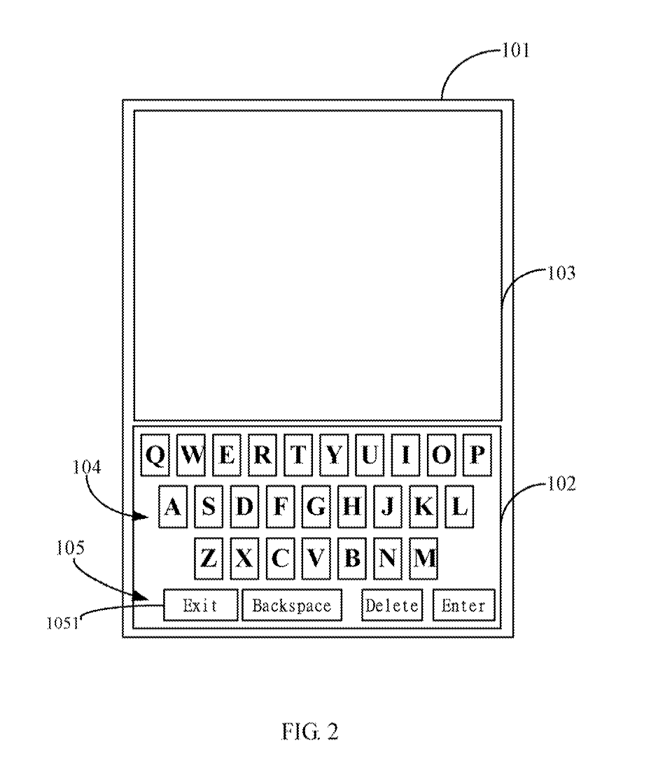

Referring to FIG. 2, when the device 100 is used to edit text, the device 100 displays a user interface 101 on the screen 10 for users to interact with the device 100. The user interface 101 includes a virtual keyboard 102 and a text display box 103 for displaying input text. The keyboard 102 includes a first button area 104 and a second button area 105. In this embodiment, the first button area 104 displays 26 letter keys which are laid out as the letter keys of a full qwerty keyboard. The second button area 104 includes a variety of function buttons, such as a delete button, an enter button, and a backspace button.

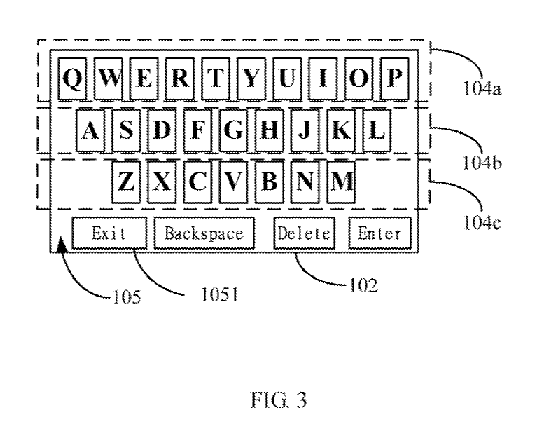

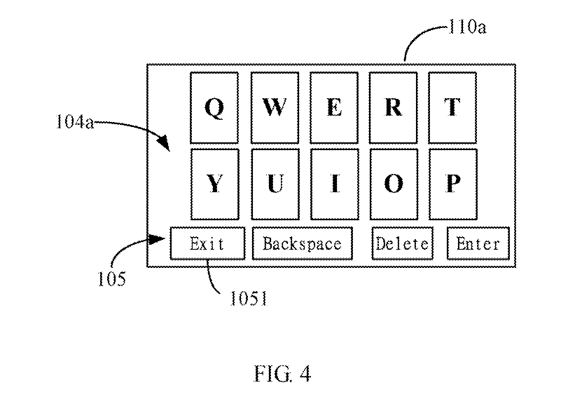

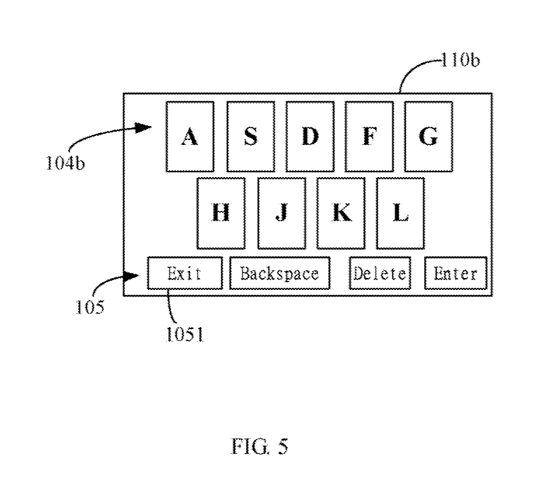

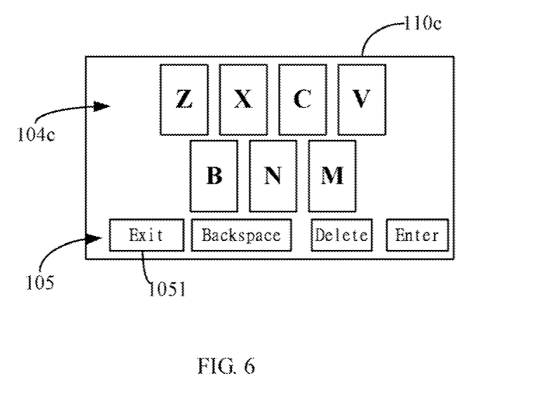

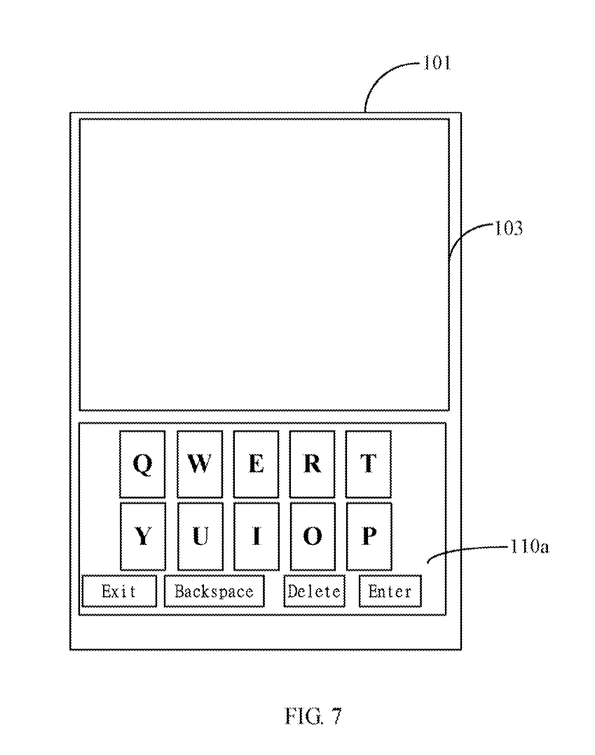

The processor 20 divides the keyboard 102 into a number of sub-keyboards, determines an input touch track according to touch signals from the screen 10, and displays a sub-keyboard according to the input touch track. FIGS. 3-7 are examples of how the keyboard 102 may be divided into a number of the sub-keyboards.

Referring to FIGS. 3-7, in this embodiment, the processor 20 divides the first button area 104 into a first sub-area 104a to include the letter keys from Q to P, a second sub-area 104b to include the letter keys from A to L, and a third sub-area 104c to include the letter keys from Z to M. The processor 20 may combine the first sub-area 104a and the second button area 105 into a first sub-keyboard 110a, or combine the second sub-area 104b and the second button area 105 into a second sub-keyboard 110b, or combine the third sub-area 104c and the second button area 105 into a third sub-keyboard 110c. The processor 20 further rearranges the letter keys of each of the sub-keyboards 110a, 110b, and 110c, and adjusts the size of the letter keys of each of the sub-keyboards 110a, 110b, and 110c, according to the arrangement of the keys of the keyboard 102, the number of the keys of each of the sub-keyboards 110a, 110b, and 110c, and the display size of the screen 10. In an alternative embodiment, the processor 20 may divide the keyboard 102 into a number of sub-keyboards according to the preference of a user. For example, the processor 20 may provide an interface for a user to select the keys to be displayed in each sub-keyboard, and the processor 20 forms each sub-keyboard according to the user's selection. Alternatively, the processor 20 may not only adjust the size of the letter keys of each sub-keyboard, but also adjust the size of the function keys of each sub-keyboard.

In this embodiment, the processor 20 defines a display order of the number of the sub-keyboards and defines at least one default touch track for switching between the sub-keyboards, and determines to display which sub-keyboard according to the display order, and a comparison of an input touch track and the at least one default touch track.

In one embodiment, the at least one default touch track may include one default touch track for switching between the sub-keyboards according to the display order. For example, the display order may be to display the sub-keyboards 110a, 110b, and 110c in sequence, and the default touch track is a fingertip of the user sliding downwards. When the keyboard 102 is the current display, if a user slides his fingertip on the screen 10 downwards, the processor 20 will display the sub-keyboard 110a. When the sub-keyboard 110a is the current display, if the fingertip slides downwards on the screen 10, the processor 20 will display the sub-keyboard 110b. When the sub-keyboard 110b is the current display, if the fingertip slides downwards on the screen 10, the processor 20 will display the sub-keyboard 110c.

In another embodiment, the at least one default touch track may include two default touch tracks. One of the two default touch tracks is for switching between the sub-keyboards according to the display order, and the other one is for switching between the sub-keyboards according to a reversed display order. For example, the display order is displaying the sub-keyboards 110a, 110b, and 110c in sequence, sliding the fingertip downwards is for displaying the sub-keyboards 110a, 110b, and 110c in sequence, and sliding the fingertip upwards is for displaying the sub-keyboards 110c, 110b, and 110a in that sequence. When the keyboard 102 is the current display, if a user slides his fingertip downwards, the processor 20 will display the sub-keyboard 110a. When the sub-keyboard 110a is being displayed, if the fingertip slides downwards, the processor 20 will display the sub-keyboard 110b. When the sub-keyboard 110b is being displayed, if the fingertip slides upwards, the processor 20 will display the sub-keyboard 110a again.

In an alternative embodiment, the processor 20 defines a number of default touch tracks where each one is for displaying a different one of the total number of the sub-keyboards, and displays a particular sub-keyboard according to the input touch track being touched and the total number of the default touch tracks. For example, sliding the fingertip downwards is for displaying the sub-keyboard 110a, sliding the fingertip upwards is for displaying the sub-keyboard 110b, and sliding the fingertip towards the left is for displaying the sub-keyboard 110c. When the keyboard 102 is being displayed, if the fingertip slides down, the processor 20 will display the sub-keyboard 110a.

In this embodiment, the function keys may include an exit key 1051 for exiting from the display of the sub-keyboards. If the processor 20 determines that the exit key 1051 has been touched, the processor 20 switches to display the keyboard 102.

In an alternative embodiment, the processor 20 may define a special touch operation, for example, double clicking on the screen 10, for exiting from the display of the sub-keyboards. If the processor 20 determines that the operation of the fingertip is the special touch operation, the processor 20 will switch to display the keyboard 102.

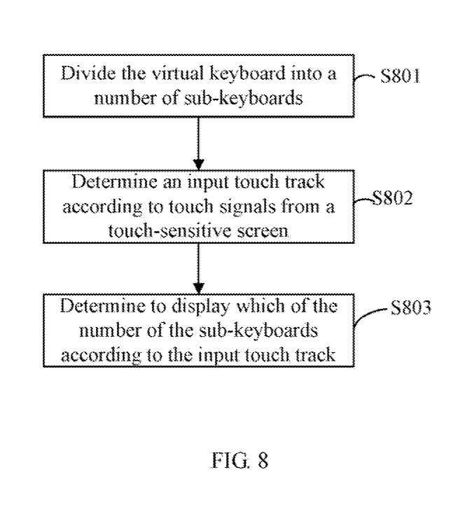

Referring to FIG. 8, in step S801, the processor 20 divides the virtual keyboard into a number of sub-keyboards.

In step S802, the processor 20 determines an input touch track according to touch signals from the screen 10.

In step S803, the processor 20 displays a particular sub-keyboard according to the input touch track.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A touch-sensitive device comprising:
a touch-sensitive screen; and
a processor to divide a virtual keyboard into a plurality of sub-keyboards, determine an input touch track according to touch signals from the touch-sensitive screen, and determine to display which of the plurality of the sub-keyboards according to the input touch track.

2. The touch-sensitive device as described in claim 1, wherein the virtual keyboard comprises a first button area and a second button area, the first button area comprises a plurality of letter keys, and the second button area comprises a plurality of function keys, the processor is to divide the first button area into a plurality of sub-areas, and combine each of the plurality of the sub-areas and the second button area into one of the plurality of sub-keyboards.

3. The touch-sensitive device as described in claim 2, wherein the processor is further to rearrange keys of each of the plurality of the sub-keyboards and adjust the size of the keys of the sub-keyboard according to an arrangement of keys of the virtual keyboard, the number of the keys of the sub-keyboard, and the display size of the touch-sensitive screen.

4. The touch-sensitive device as described in claim 2, wherein the processor is further to rearrange the letter keys of each of the plurality of the sub-keyboards and adjust the size of the letter keys of the sub-keyboard according to an arrangement of keys of the virtual keyboard, the number of the keys of the sub-keyboard, and the display size of the touch-sensitive screen.

5. The touch-sensitive device as described in claim 1, wherein the processor is further to define a display order of the plurality of the sub-keyboards and define at least one default touch track for switching between the plurality of the sub-keyboards, and determine to display which of the plurality of the sub-keyboards according to the display order, and a comparison of an input touch track and the at least one default touch track.

6. The touch-sensitive device as described in claim 5, wherein the at least one default touch track comprises one default touch track for switching between the plurality of the sub-keyboards according to the display order.

7. The touch-sensitive device as described in claim 5, wherein the at least one default touch track comprises two default touch tracks, one of the default touch tracks is for switching between the plurality of the sub-keyboards according to the display order, and the other one of the default touch tracks is for switching between the plurality of the sub-keyboards according to a reversed display order.

8. The touch-sensitive device as described in claim 1, wherein the processor is further to define a plurality of default touch tracks each for displaying a different one of the plurality of the sub-keyboards, and determine to display which of the plurality of the sub-keyboards according to a comparison of an input touch track and the plurality of the default touch tracks.

9. The touch-sensitive device as described in claim 1, wherein the processor is further to define a special touch operation for exiting from the display of the plurality of the sub-keyboards, and switch to display the virtual keyboard if the processor determines that a user's touch operation is the special touch operation.

10. The touch-sensitive device as described in claim 2, wherein the function keys comprises an exit key for exiting from the display of the plurality of the sub-keyboards, and switch to display the virtual keyboard if the processor determines that the exit key has been touched.

11. A method for controlling display of a virtual keyboard applied in a touch device, the method comprising:
dividing the virtual keyboard into a plurality of sub-keyboards;
determining an input touch track according to touch signals from a touch-sensitive screen of the touch device; and
determining to display which of the plurality of the sub-keyboards according to the input touch track.

12. The method as described in claim 11, wherein the virtual keyboard comprises a first button area and a second button area, the first button area comprises a plurality of letter keys, and the second button area comprises a plurality of function keys, the step of “dividing the virtual keyboard into a plurality of sub-keyboards” comprises:
dividing the first button area into a plurality of sub-areas; and
combining each of the plurality of the sub-areas and the second button area into one of the plurality of sub-keyboards.

13. The method as described in claim 12, wherein the step of “dividing the virtual keyboard into a plurality of sub-keyboards” further comprising:
rearranging keys of each of the plurality of the sub-keyboards and adjusting the size of the keys of the sub-keyboard according to an arrangement of keys of the virtual keyboard, the number of the keys of the sub-keyboard, and the display size of the touch-sensitive screen.

14. The method as described in claim 12, wherein the step of “dividing the virtual keyboard into a plurality of sub-keyboards” further comprising:
rearranging the letter keys of each of the plurality of the sub-keyboards and adjusting the size of the letter keys of the sub-keyboard according to an arrangement of keys of the virtual keyboard, the number of the keys of the sub-keyboard, and the display size of the touch-sensitive screen.

15. The method as described in claim 11, further comprising:
defining a display order of the plurality of the sub-keyboards and defining at least one default touch track for switching between the plurality of the sub-keyboards; and
determining to display which of the plurality of the sub-keyboards according to the display order, and a comparison of an input touch track and the at least one default touch track.

16. The method as described in claim 15, wherein the at least one default touch track comprises one default touch track for switching between the plurality of the sub-keyboards according to the display order.

17. The method as described in claim 15, wherein the at least one default touch track comprises two default touch tracks, one of the default touch tracks is for switching between the plurality of the sub-keyboards according to the display order, and the other one of the default touch tracks is for switching between the plurality of the sub-keyboards according to a reversed display order.

18. The method as described in claim 11, further comprising:
defining a plurality of default touch tracks each for displaying a different one of the plurality of the sub-keyboards; and
determining to display which of the plurality of the sub-keyboards according to a comparison of an input touch track and the plurality of the default touch tracks.

19. The method as described in claim 11, further comprising:
defining a special touch operation for exiting from the display of the plurality of the sub-keyboards; and
switching to display the virtual keyboard if determining that a user's touch operation is the special touch operation.
